(19) United States
(12) Patent Application Publication
(10) Pub. No.: US 2015/0183257 A1
(43) Pub. Date: Jul. 2, 2015

(54) Verification Of Pharmaceutical Product Packaging To Prevent Counterfeits, Using Hidden Security Features Revealed With A Laser Pointer

(71) Applicant: I-Property Holding Corp., Sarasota, FL (US)

(72) Inventors: Paul Glendenning, Kandern (DE); Stefan Klocke, Karlsruhe (DE); Alexander Stuck, Wettingen (CH); Thomas Gering, Sarasota, FL (US)

(21) Appl. No.: 14/587,690

(22) Filed: Dec. 31, 2014

Related U.S. Application Data
(60) Provisional application No. 61/922,508, filed on Dec. 31, 2013.

(51) Int. Cl. B42D 25/30; B65D 25/20; G06K 19/16; G03H 1/00; G06K 19/06

(52) U.S. Cl. CPC B42D 25/30; G03H 1/0011; G06K 19/06065; G06K 19/16; B65D 25/20; G03H 2001/0016

(57) ABSTRACT

Pharmaceutical tablets and dosage forms are stored in a blister pack or other type of packaging which include additional anti-counterfeiting measures that are difficult to simulate and easy to reveal with a laser pointer. The blister pack is embossed with a hidden security feature including hidden information that is revealed only when a laser beam is directed through the packaging to be deflected at the hidden security feature. The hidden security feature may also accompany other covert and/or overt security features, including multi-level hologram features embossed into the blister pack at the same time as the hidden security feature.

### CROSS-REFERENCE TO RELATED APPLICATION

This application claims priority to U.S. Provisional Application Ser. No. 61/922,508, filed Dec. 31, 2013. This prior application is incorporated herein by reference, in its entirety.

### TECHNICAL FIELD

The present invention relates to anti-counterfeiting measures used with pharmaceuticals, and more specifically, is related to measures used with blister-style and other types of packaging used with pharmaceuticals.

### BACKGROUND

The state of the art in anti-counterfeiting for pharmaceutical tablet blister packaging includes overt and covert features. Currently used anti-counterfeiting methods include the following:
Serialization of blister packs with printed barcodes for track and trace purposes, and verification of these against a database at supply chain stages and/or in dispensing.
Holograms on primary packaging or as part of tamper evident features.
Use of special inks such as UV or IR visible ink, thermo-chromic inks, etc.
Use of covert taggants which may be chemical, biological or DNA based.
Application of a printed code to the package that is revealed when a layer is rubbed away. The code is then sent by text message to a number where a verification is returned by text message back to the user. A similar system uses a barcode that can be scanned by mobile phone to link to a website for verification.

Serialization of drug packaging is now starting to be widely implemented on pharmaceutical production lines in Europe and the U.S. There are different systems being tested and these allow different levels of checking in the supply chain. Furthermore, different database monitoring methods are being tested and monitored. Who should control and fund these control systems and exactly how they should work remains a matter of discussion. See, e.g., The European Serialization Landscape, by Mark Davidson, Blue Sphere Health Ltd, Cambridge, U.K., May 2012. The U.S. and Europe have different approaches to the issue of serialization and so-called “track & trace.” The European system allows checking even at the dispensing level. The U.S. system allows checking only when a transfer of ownership occurs. See e.g., Serialization—EU's track & trace vs. US's E-pedigree, by Jim Chrzan, Healthcare Packaging, March 2013 (http://www.healthcarepackaging.com/trends-and-issues/traceability-and-authentication/serialization-eus-track-and-trace-versus-uss-e).

Hologram technology where the hologram is applied using plastic and metalized film materials is well established. An example is the well-known holograms on credit cards.

An example of the printed code or barcode verified by phone/text is the Sproxil system currently in use in parts of Africa and other developing countries. See e.g., Powered by Mobile Technology to Combat Counterfeiting (http://sproxil.com/sms-verification.html).

Serialization has the disadvantage that it requires a database and that it is complex to implement. One issue to be resolved is ownership, management of, and access to the database, to ensure that the information is readily accessible and yet secure against compromise. See e.g., Anti-counterfeit Technologies for the Protection of Medicines, World Health Organization IMPACT report (http://www.who.int/impact/events/IMPACT-ACTechnologiesv3LIS.pdf). Another issue is that printed barcodes are easy to create and there is no guarantee that the genuine barcode will reach the dispenser before the counterfeit barcode.

Holograms, especially those on packaging films, have the disadvantage that a hologram can be easily obtained which may make a product look genuine when it is not. If a customer or distributor is not informed and careful enough to be able to distinguish the genuine hologram from the fake hologram, any similar hologram can give false assurance.

Special inks are printable by anyone who can obtain them, and can be used to print a copy of similar information that would be present on the genuine article.

Taggants are only verifiable by specific equipment with the correct technology to reveal them. This makes them expensive to use and means that for verification, the packaging has to be sent to a special laboratory.

The mobile-phone verifiable printed codes and barcode scans are open to counterfeiters who are able to generate fake codes and verification numbers, or fake websites that the fake barcodes link to. Counterfeiters will go to considerable effort to make fake sites appear overtly genuine.

Thus, it is desirable to improve anti-counterfeiting measures used in this field, especially with pharmaceuticals that may travel through supply chain points in poorer regions of the world. More specifically, it is desirable to provide a reliable low-cost authentication process that may be used with pharmaceuticals at any position along the supply chain between the initial manufacturer and the final consumer.

### SUMMARY

In one embodiment according to the disclosed invention, a method is provided for discouraging counterfeiting of pharmaceutical products. The method includes providing a packaging with a genuine pharmaceutical and with a hidden security feature formed integrally by material defining the packaging. The method also includes verifying the authenticity of the pharmaceutical by directing a laser beam through the packaging at the hidden security feature. This directing of the laser beam reveals the hidden security feature on a surface behind the packaging. Therefore, a simple and rapid authentication of the pharmaceutical can be conducted at any point in the supply chain between the manufacturer and the end consumer, using only inexpensive equipment like a conventional laser pointer.

In some aspects, the packaging is further provided with one or more additional security features that may be confirmed visually or with a machine during authentication of the pharmaceutical. The additional security features in combination with the hidden security feature collectively define a unique digital signature for the packaging that may be tracked as required by some local regulations and laws. The additional security features in some embodiments include one or more of: microtext defining depth and lateral dimensions between 2 microns and 100 microns; a hologram acting as an overt security feature on the packaging; and a barcode located on the packaging or on an outer packaging box into which the packaging is typically loaded for transfer along the supply chain. Such a barcode may also independently provide identification and/or serialization functionality to comply with local regulations and laws.

When the additional security features include a hologram, that hologram may provide one or more levels of additional security verification features. In this regard, the hologram in one embodiment diffracts light differently at different viewing angles to visually change color at the different viewing angles. In further embodiments, the hologram also diffracts light so as to present a first image (like a globe) at some viewing angles and a distinct second image (like a set of meridians and parallels) at other viewing angles. In still further embodiments, the hologram also includes the hidden security feature and/or a detectable irregularity formed integrally within the hologram. The hidden security feature is revealed by the laser beam, while the detectable irregularity is covert but identifiable with a 3D scanner. These additional security levels provide further challenges to potential counterfeiters above and beyond the hidden security feature revealed only by laser pointer.

The packaging used with these methods may define different form factors to suit the practices of various countries. To this end, the packaging in one aspect includes a blister pack with a foil coating. A portion of the foil coating must be removed adjacent to the hidden security feature to enable the laser beam to be directed through the packaging to reveal the hidden security feature. In other aspects, the packaging includes a pill bottle with a closure cap, the hidden security feature being provided in one or both of the pill bottle and the closure cap. The process of verifying the authenticity of the pharmaceutical with the laser beam is performed within 1 second without reliance on communication with external databases during the verifying of the authenticity. Therefore, the method provides sufficient protections from counterfeiting efforts while also enabling simple and inexpensive authentication to be performed at all locations in a supply chain, even when in poorer countries or regions.

In another embodiment according to the disclosed invention, a pharmaceutical product is configured to discourage counterfeiting. The product includes one or more dosage forms and a packaging configured to receive and securely hold the one or more dosage forms. The packaging is defined by a material and includes a hidden security feature that is formed integrally by the material defining the packaging. The hidden security feature deflects laser energy transmitted through the packaging such that a laser beam directed through the packaging at the hidden security feature reveals the hidden security feature on a surface behind the packaging to thereby verify the authenticity of the pharmaceutical. The pharmaceutical product may also include the additional security features and different types of packaging as described above.

These and other objects and advantages of the disclosed apparatus will become more readily apparent during the following detailed description taken in conjunction with the drawings herein.

### BRIEF DESCRIPTION OF THE DRAWINGS

The accompanying drawings, which are incorporated in and constitute a part of the specification, illustrate embodiments of the invention and, together with the general description above, and the detailed description of the embodiments below, serve to explain the principles of the invention outlined in this disclosure.

FIG. 1 is a schematic view showing a generic supply chain for a pharmaceutical and a representation of the verification/authentication process enabled at all points of the supply chain based on the combination of security features located on the product packaging, these security features including at least one hidden feature that is revealed by directing a laser from a laser pointer through the product packaging at the hidden feature.

FIG. 2A is a perspective view of one embodiment of a blister pack according to the invention wherein the Aluminum foil coating is removed from the blister packaging in the specific area of the hidden feature, by rubbing or peeling away the foil coating.

FIG. 2B is a perspective view of the hidden feature being revealed in the blister pack of FIG. 2A using a green laser pointer projected through the plastic package onto another surface.

FIG. 3 is a perspective view of a standard embossing station on a commercial blister packing machine used in a pharmaceutical company for the packaging of tablets, including the addition of the hidden feature used with the blister pack of FIGS. 2A and 2B.

FIG. 4 is a perspective view of another embodiment of a blister pack according to the invention, which includes an example of an overt hologram applied to the blister pack.

FIG. 5 is a bottom perspective view of a hard steel embossing insert with a hologram micro-structure on the embossing surface, which is used to emboss the overt hologram into the blister pack of FIG. 4.

FIG. 6 is a perspective view of an embossing tool used with the standard embossing station of FIG. 3, showing a hidden security feature detail on the tool by reflecting a laser pointer off of the portion of the embossing tool having the hidden security feature that gets transferred to blister packs as a part of the hologram.

FIG. 7 is a schematic view showing the verification/authentication process using a hidden feature revealed by a laser pointer, as used with a different embodiment of product packaging, specifically a pill bottle with a removable lid closure.

FIG. 8A is a bottom perspective view of a hard steel embossing insert with an embossing surface for forming a multi-level hologram security feature, in accordance with another embodiment of the invention.

FIG. 8B is a package element including the multi-level hologram security feature provided by the embossing insert of FIG. 8A.

FIG. 9 is a schematic illustration of a second type of the multi-level hologram security feature that may be provided by the embossing insert of FIG. 8A, with different images revealed at different viewing angles or orientations.

FIG. 10 is a schematic perspective view of the second type of multi-level hologram security feature of FIG. 9, as would be used on packaging.

FIG. 11A is a top view of a closure cap type of packaging including the multi-level hologram security feature shown schematically in FIGS. 9 and 10, the hologram security feature having a first appearance at a first viewing angle.

FIG. 11B is a top view of the closure cap packaging of FIG. 11A, with the packaging rotated through a small angle to reveal a changing appearance of the multi-level hologram security feature at different viewing angles.

FIG. 11C is a top view of the closure cap packaging of FIG. 11B, with the packaging further rotated through a small angle to reveal a changing appearance of the multi-level hologram security feature at different viewing angles.

FIG. 11D is a top view of the closure cap packaging of FIG. 11C, with the packaging further rotated through a small angle to reveal a changing appearance of the multi-level hologram security feature at different viewing angles.

### DETAILED DESCRIPTION

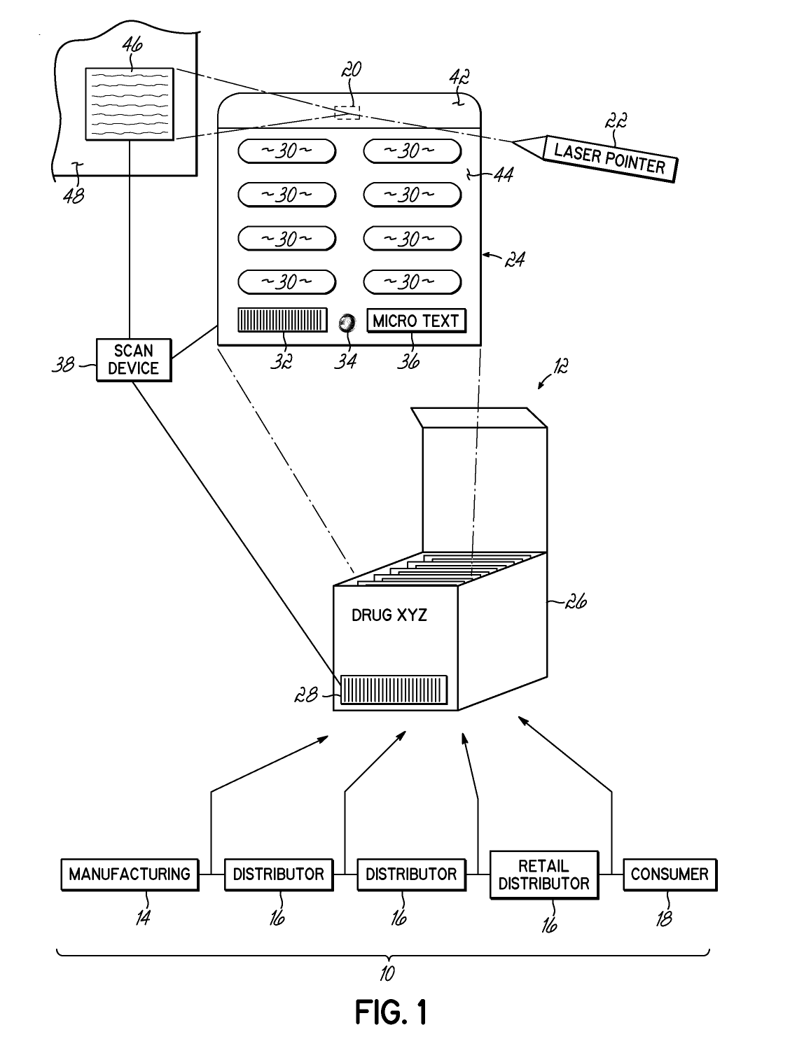

According to the embodiments of the disclosed invention, a packaging for pharmaceutical products is provided with covert and/or overt security features which may be used to authenticate or verify the authenticity of the pharmaceutical product at various locations along a typical supply chain for the pharmaceutical. To this end, FIG. 1 generally shows a supply chain 10 in which a pharmaceutical product 12 is produced and packaged at a manufacturer 14, and then is transferred through a series of distributors 16 before reaching the end consumer 18. At each of the transfer points, it may be desirable or required by local laws to verify the authenticity of the products 12 being transferred between parties in the supply chain 10. The security features included with the packaging advantageously include at least one hidden security feature 20 which may be revealed by directing a laser beam from a conventional laser pointer 22 through the packaging at the hidden security feature 20. This hidden security feature 20 enables inexpensive equipment to be used to verify the authenticity of the pharmaceutical product 12 rather than smart phone (which requires complex and reliable connection to a satellite network and/or external databases) or complex 3D scanning equipment, thereby enabling some level of product authentication even when the supply chain 10 includes some poorer parts of the world. Various embodiments and combinations of security features including this hidden security feature 20 are described in further detail below.

With continued reference to FIG. 1, the product packaging 24 shown schematically is a blister pack 24, which may be transferred with additional blister packs 24 inside an outer packaging box 26. As described above, local laws and regulations requiring serialization of pharmaceutical packaging may require a unique barcode 28 to be located on the outer packaging box 26 as shown. Furthermore, each blister pack 24 includes cavities 30 for receiving pharmaceuticals and one or more security features such as: the hidden security feature 20 revealed by directing a laser beam from a laser pointer 22 through the blister pack 24 as schematically shown; a 2D barcode 32; a hologram 34; and microtext 36, each of which may be embossed into the blister pack 24 and detected by an appropriate scan device 38, in accordance with known packaging and verification techniques. The various additional security features are shown on an opposite end of the blister pack 24 from the hidden security feature 20 in FIG. 1, but it will be understood that these elements may be formed at different or the same location, such as by being coextensive with one another. The combination of security features provided on the blister packs 24 and on the outer packaging box 26 can collectively define a unique digital signature for the pharmaceuticals, which may be used in addition to the rapid authentication with the laser pointer 22 through the hidden security feature 20 to provide the anti-counterfeiting protections necessary in the field of pharmaceuticals.

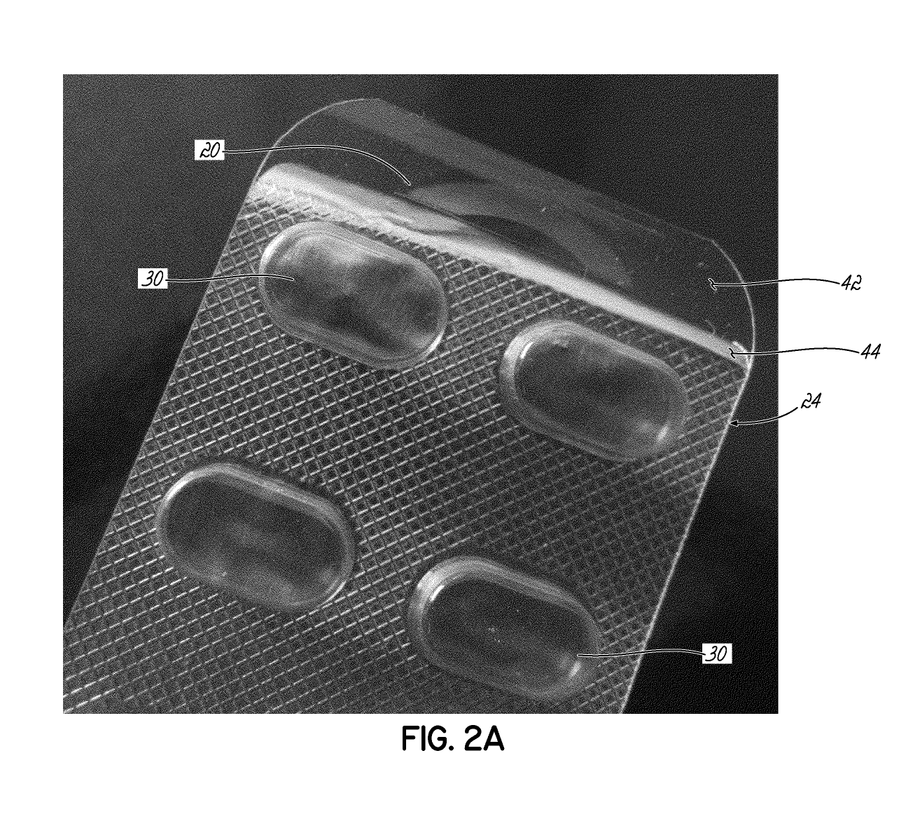

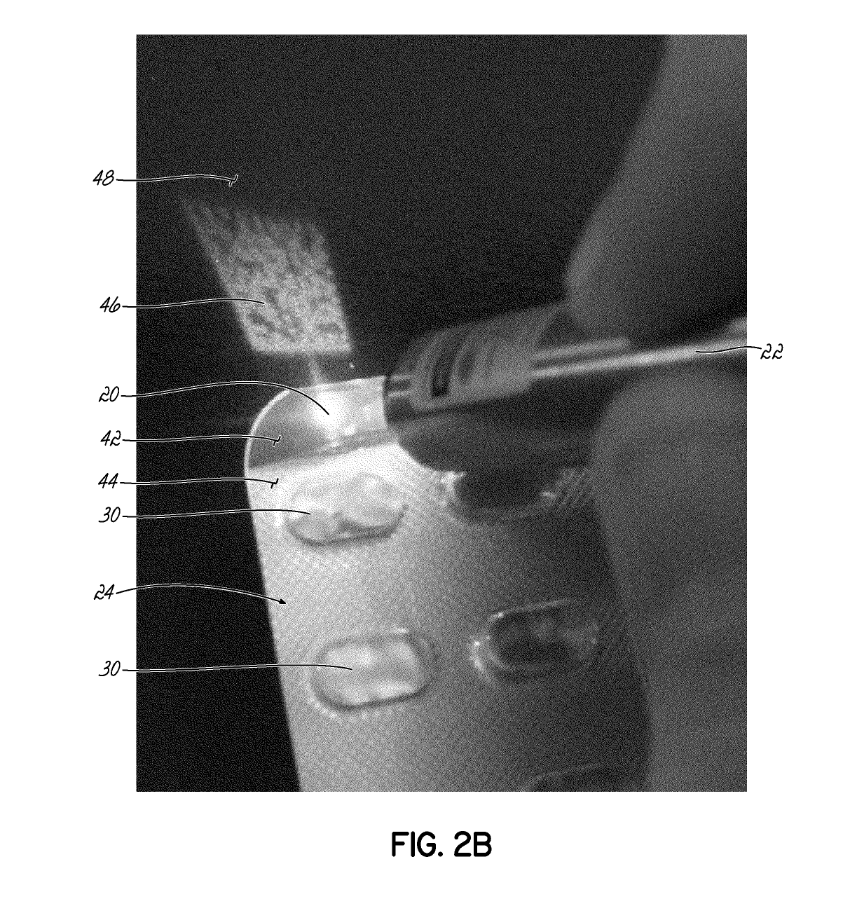

In one embodiment shown in FIGS. 2A and 2B, hidden information in the form of a hidden security feature 20 is concealed in the plastic material 42 of a pharmaceutical blister pack 24 during the packaging of tablets or other dosage forms, and revealed for security verification using a simple commercial laser pointer 22 directed through a specific area of the package. When a particular area of the aluminum foil 44 on the blister pack 24 is removed (FIG. 2A), the hidden information 46 is revealed by projecting the beam of the laser pointer 22 through the plastic material 42 onto a surface 48 behind the plastic (FIG. 2B). This hidden information 46 may be any type of code or logo that indicates a genuine article, and the hidden security feature 20 may be located at an overt location on the blister pack 24 or on a covert/hidden location, such as the example shown in FIGS. 2A and 2B.

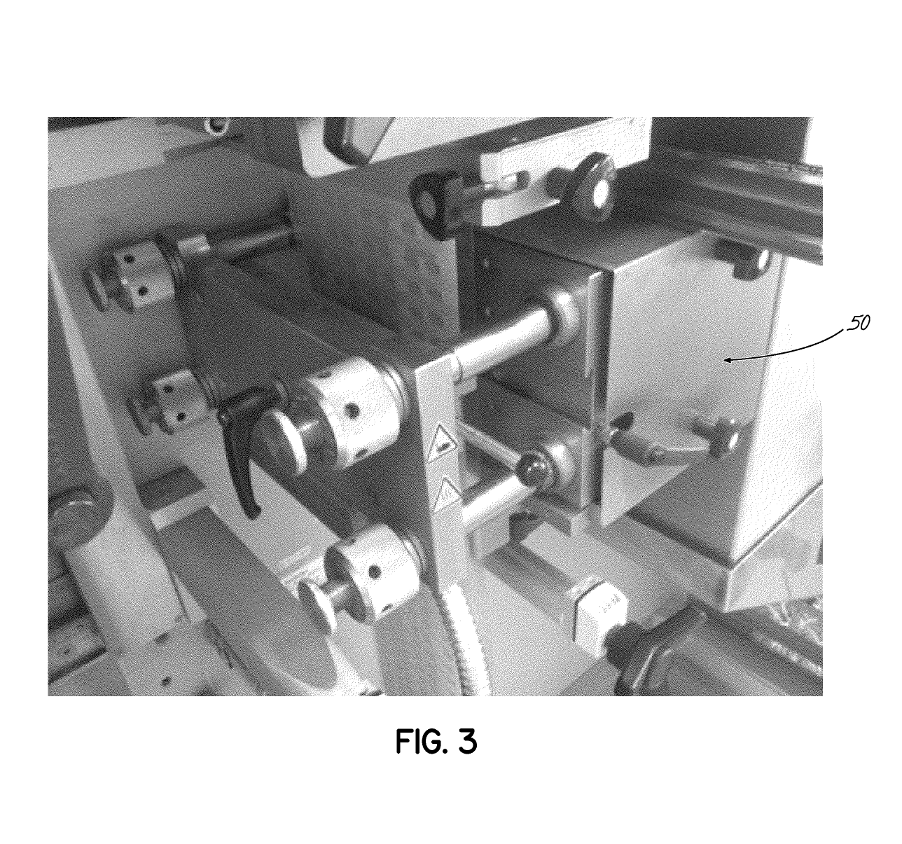

To produce this hidden security feature 20, a diffractive optical grating pattern is embossed into the surface of the PVC blister pack 24. This takes place as part of a normal in-line pharmaceutical tablet packaging process on a blister-packaging machine. A standard embossing station 50 on the machine, such as that previously designed for embossing batch codes, can be used to emboss the diffractive grating structure (FIG. 3). This station 50 has been used to emboss the diffractive features onto the blister packages 24. Such an embossing station 50 can include heating units to help control the embossing process. Further exemplary details of the embossing tools and other embodiments of the security features embossed into blister packs 24 are provided in alternative embodiments below.

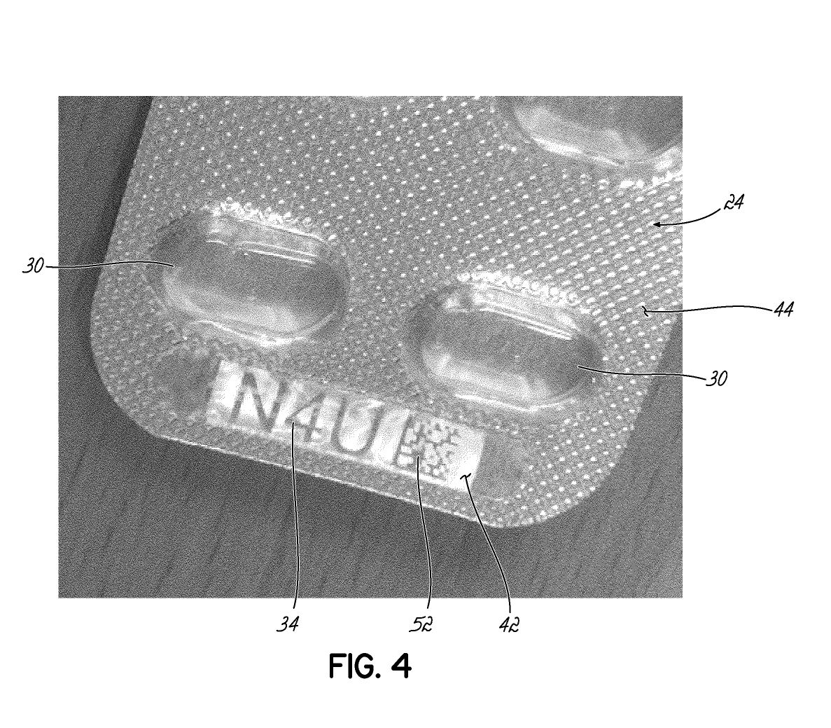

If desired, an overtly visible hologram 34 can be produced during the same manufacturing process that can be seen brightly in sunlight or white artificial lighting (FIG. 4). Another option is to emboss a 2D or 3D barcode 32, 52 into the surface on the material 42 as part of the same process that can be read by a commercial scanner (such as element 38). In both cases the hidden security feature 20 is only revealed when the aluminum foil 44 is selectively removed and the laser pointer 22 is directed in the specific location needed. Thus, a combination of an overt security feature and a hidden security feature 20 are provided, which will lead most counterfeiters to replicate only the overt information.

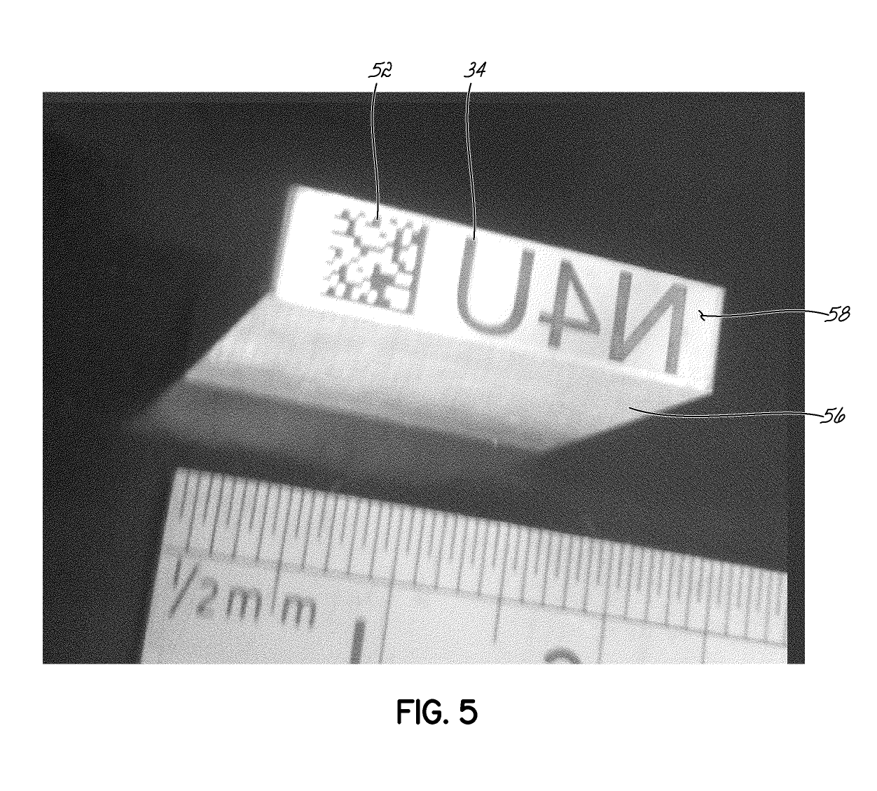

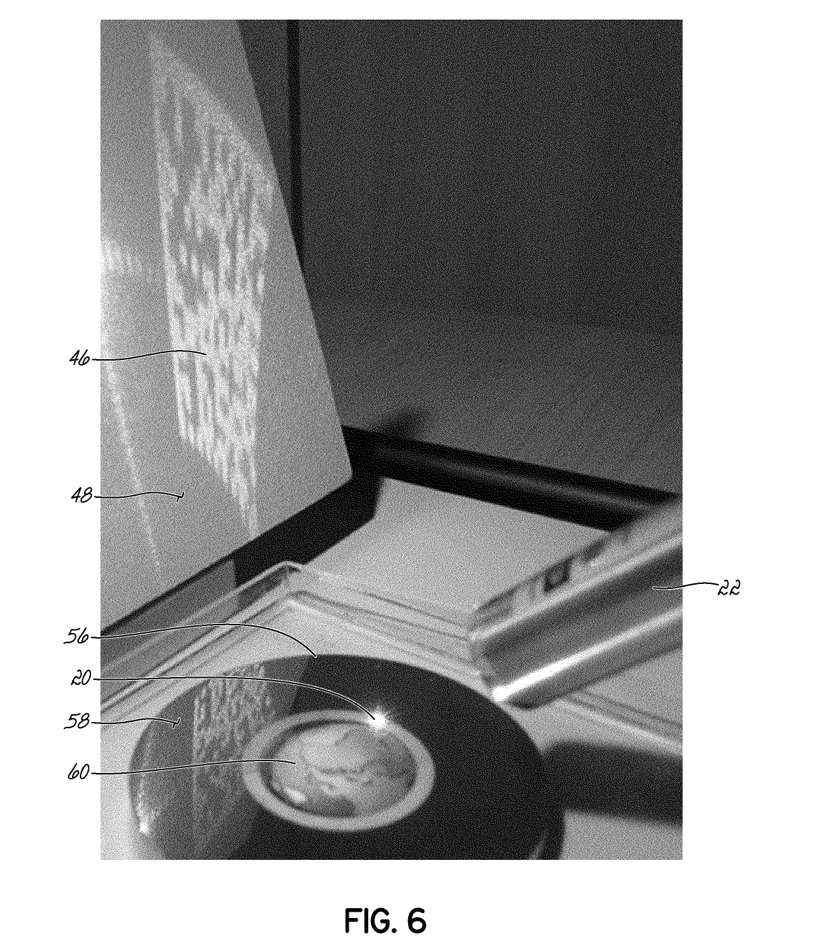

Tooling for the embossing process may be manufactured by applying the diffractive structure needed into a hardened tool steel insert 56 (FIG. 5) or onto other conventional types of embossing tools, such as those made of nickel and similar materials. When used, the hard steel insert 56 performs the embossing and can hence last for millions of embossing cycles. However, the hardened steel insert 56 operates with functionality identical to that of conventional embossing equipment so that hundreds or thousands of pharmaceutical tablets and packages can be generated per hour of machine operation. The steel insert 56 may also reveal the hidden security feature 20 when a laser pointer 22 is deflected off the relevant embossing surface 58 (FIG. 6) and when the more complex (multi-level security) hologram 60 includes the hidden security feature 20 as set forth in further detail below. Although the specific holograms 34, 60 produced by the different tools or inserts 56 shown in FIGS. 5 and 6 are different, both are configured to define overt and (optionally) also covert/hidden security features into the structure embossed into the pharmaceutical packaging 24.

In addition to the hidden security feature, the tooling and embossing process used allows for complex holograms 60, for example showing different images in different viewing orientations, to be produced and embossed. This process also allows for further types of diffractive structures to be produced in the steel and embossed, including random structures and Moiré structures.

The hidden information revealed by the laser pointer 22, through the reconstruction of the image hidden in the diffractive optics, can include any kind of lettering or pattern. For example, it can be a logo, or 2-D bar code pattern that can be photographed and decoded. In another example, the lettering is in the form of microtext 36 having depth and/or lateral dimensions between 2 microns to 100 microns.

One advantage of these embodiments is allowing the hidden security feature 20 on the blister pack 24 to be verified using a simple laser pointer 22. The verification can be done by the manufacturer 14 (without informing the end consumer 18 that the feature is there) or by others in the supply chain 10 including the end consumer 18, who can verify the feature if the manufacturer 14 chooses to inform them of its presence, the location where it can be found on the packaging 24, and how it can be checked. Furthermore, the laser pointer 22 revealing of the hidden security feature 20 is nearly instantaneous and does not require communication with an external database, thereby enabling one type of verification of the pharmaceutical product 12 to be performed in less than 1 second of time (by contrast, sending scanned codes to an external database and waiting for verification takes a few seconds, at minimum, for each packaging 24).

The use of the hidden security features 20 enables easy checks at any point in the supply chain 10, including in poorer countries, where laser pointers 22 can be purchased. The conventional mobile phone authentication method described in the background allows for supply chain 10 checks but is subject to the abuses of the system described above (fake verification websites for fake codes), and also requires cost-prohibitive mobile phone technology to be accessible at each point in the supply chain 10. Allowing consumers 18 the possibility to check a genuine product 12 themselves means that even internet-purchased blister packages 24 of drugs can be checked for authenticity. This, and allowing checks at different supply chain points even in poorer countries, is fully in accordance with one of the recommendations from the United Nations Institute for Interregional Crime and Justice Research Institute (UNICRI), as a result of the European research project “SAVEmed.” See, e.g., www.savemed.org.

Because the hidden security feature in these embodiments is integrally formed as a unitary piece with the plastic material 42 and is embossed into the packaging 24, the verification cannot be faked by applying another hologram 34, 60 or film. In addition, the hidden security feature 20 cannot be removed or rewritten in any way.

Another advantage of these embodiments is that the hidden security feature is very hard to copy. In order to create the same feature, the counterfeiter would have to be able to copy the diffractive optical design from the surface of the blister pack 24 (this is only possible using special technology and special materials in high technology laboratories). The counterfeiter would then also have to be able to make a similar embossing stamp to generate the hidden security feature 20 and other features on the blister packaging machinery, which can be complex and difficult.

The hidden security feature can be concealed as part of an overt hologram 60 or combined with an embossed barcode. This may lead the counterfeiter to copy the overt feature without realizing that the covert feature is present in the same area of the package.

A further advantage is that the hidden security feature can be designed to include a 2D barcode (e.g., the hidden information 46) that is revealed by the laser pointer 22. In principle, it is possible to write a software application, such as a mobile phone application, for example, to scan the barcode and read the 2D barcode. The barcode itself can contain encrypted information allowing for a range of security enhancements.

Because the verification is within the blister pack 24 itself, no database access or database management is needed for performing the authentication or verification of the blister pack 24. More specifically, verification codes and data do not need to be sent to external databases for verifying the authenticity of a blister pack 24 and its contents. As a result, verification of the blister pack 24 occurs immediately upon illumination of the hidden security feature 20 with the laser pointer 22, which means blister packs 24 are verified as authentic within one second. Conventional systems reliant on communication with external servers do not compare favorably with the time efficiency offered by this anti-counterfeiting and authentication process.

As no additional materials are added to the packaging 24, the only additional cost to the manufacturer 14 is the embossing tooling containing the diffractive structure. A further advantage of this is that the pharmaceutical manufacturer 14 has no additional approvals or documentation to complete because of changes to the materials or process steps.

Packaging Different from Blister Packs

The embodiments described herein are potentially useful also in markets where—to date—the majority of dosage form deliveries do not use blister packs 24 but where dosage forms are shipped in bulk and re-packaged along the supply chain 10. Although there is a certain trend in the United States to introduce blister packs 24, bulk-deliveries and re-packaging will still be possible after introduction of new serialization policies, beginning with California state law to become effective in 2015. The so-called electronic pedigree requires a “record, in electronic form containing information regarding each transaction resulting in a change of ownership of a given dangerous drug, from sale by a manufacturer 14, through acquisition and sale by one or more wholesalers, manufacturers, or pharmacies, until final sale to a pharmacy or other person furnishing, administering or dispensing the dangerous drug. The pedigree shall be created and maintained in an interoperable electronic system, ensuring compatibility throughout all stages of distribution.” See California Business and Professions Code Section 4034 (a).

The rules regarding the pedigree do not, however, dictate the technological implementation of identifiers put onto pharmaceutical packaging, such as blister packs 24 or bulk packaging. In fact, the California government's written summary on e-pedigree laws says specifically: “The unique identifier . . . on each saleable container of prescription drugs will most likely be carried on either a 2D bar code or an RFID chip placed on the saleable unit by the manufacturer 14. The California Legislature has not mandated these specific technologies, but they are the two methods that have been identified that could meet the requirements of the legislation.”

It is therefore in the interest of U.S. pharmaceutical manufacturers, and all pharmaceutical manufacturers 14 selling products 12 in the United States—or the State of California for that matter—to select their specific technological implementation that will ensure compliance with the new serialization requirement.

The embodiments described herein not only are uniquely capable of achieving compliance by pharmaceutical manufacturers 14 with those new rules, but also are superior to the straightforward application of minimum coding requirements in the form of 2D bar codes or RFID chips, in that the application of additional overt and/or covert security features will easily allow the creation of full-scale digital finger-printing down to the product level (and integration into manufacturer supply chain management systems), should manufacturers 14, distributors 16 and consumers 18 desire even greater levels of security against counterfeiting. Several of these combinations are set forth in greater detail below.

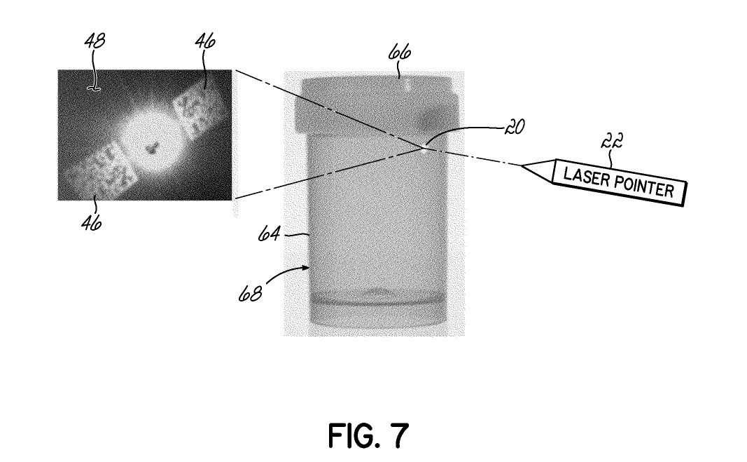

Furthermore, as shown in FIG. 7, the hidden security features 20 described above may be provided in a sidewall 64 (as shown) or in a cap 66 (not shown in this Figure) of an injection molded pill bottle 68, which is more typically used to transmit pharmaceuticals in countries like the U.S. instead of blister packs 24. The simple verification process with a laser pointer 22 revealing the hidden information 46 included in the hidden security feature 20 is performed in precisely the same manner as described above for a blister pack 24, and this process is schematically shown once again in this FIG. 7. Therefore, the benefits of the hidden security feature 20 may also be achieved with other types of packaging without departing from the scope of this disclosure.

### Additional Security Features

It will also be understood that the holographic or hidden security feature 20 may be combined with additional security features on the dosage form and/or the packaging. These additional security features further enhance the guard against counterfeiting of the packaging and of the pharmaceutical dosage forms themselves.

For example, the dosage form may include data matrix codes such as microstructured and nanostructured surfaces as disclosed in U.S. patent application Ser. No. 12/761,993 to Klocke et al., entitled “Manufacturing Solid Pharmaceutical Dosage Forms with Visible Micro- and Nanostructured Surfaces and Micro- and Nanostructured Pharmaceutical Dosage Forms,” which was filed Apr. 16, 2012 and the entirety of which is hereby incorporated by reference herein (most recently published as U.S. Patent Publication No. 2014/0255482).

In another example, the dosage form and the packaging may include complementary features for optical verification (man or machine), such as the Moire patterns formed in U.S. Pat. No. 8,323,623 to Klocke et al., entitled “Pharmaceutical Moire Pill,” and the entirety of which is hereby incorporated by reference herein.

Moreover, multiple structures may be used to provide additional optical contract or authentication/verification of the pharmaceutical and/or packing, as described in U.S. Pat. No. 8,715,725 to Stuck et al., entitled “Secure Tracking of Tablets,” and the entirety of which is hereby incorporated by reference herein, and also disclosed in U.S. Patent Publication No. 2011/0186629 to Stuck et al., entitled “Method For The Authentication of Dosage Forms,” which was filed Jan. 20, 2011 and the entirety of which is hereby incorporated by reference herein.

As briefly described above, a generalized example of one or more additional security features on the same blister pack 24 as the hidden security feature 20 is shown in FIG. 1. To this end, on an opposite end from the hidden security feature 20, the blister pack 24 may include one or more of: a 2D barcode 32, a hologram 34 (which may include detectable defects and/or irregularities unique to the embossing tooling used to form the hologram 34, as set forth in further detail below), and lettering in the form of microtext 36. As noted above, the microtext 36 defines depth and/or lateral dimensions between 2 microns to 100 microns. To this end, a microtext 36 may cover a larger area on the blister pack 24 of several millimeters across (e.g., such as a 10 millimeter by 10 millimeter square of microtext 36). In practice, the micron sized features (microtext 36) are distributed over this area, but the features need not be connected.

It will be understood that only one or any combination of these and other known types of overt security features may be located on the same blister pack 24 as the hidden security feature 20 in other embodiments consistent with the scope of this disclosure, the combination of all these security features collectively defining a unique digital signature for the blister pack 24. Therefore, in addition to the verification or authentication process enabled by shooting a laser pointer 22 through the hidden security feature 20, this unique digital signature may also be verified or authenticated at any point in the supply chain 10 for the pharmaceutical products 12.

Each of these additional security features may be used in any combination with the holographic overt and hidden security features described above, to further enhance the anti-counterfeiting measures.

### Multiple-Level Hologram Verification

In some embodiments, the hologram 60 embossed onto the blister package 24 can contain multiple levels of security verification. For example:

Level 1: Visual hologram image effect.

Level 2: Hologram image that changes with different viewing angle (e.g., a 90° or 180° turn).

Level 3: Hidden detail verification.

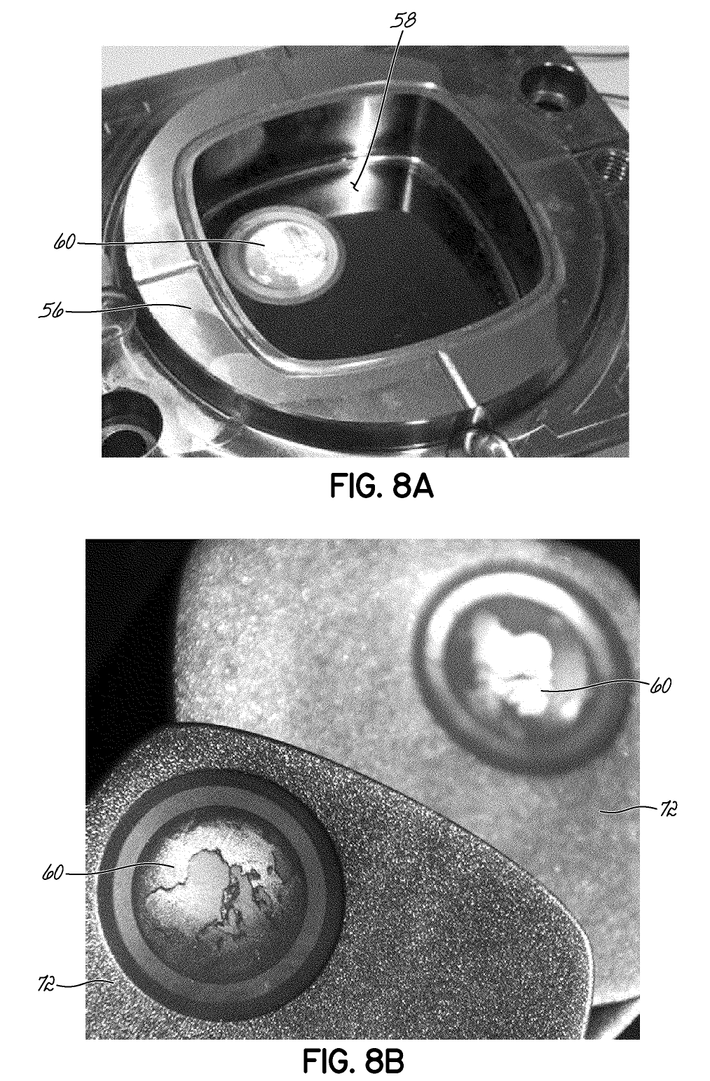

For an example of the Level 1 hologram verification, the embossing tool formed from a hardened steel insert 56 may be modified to include an embossing surface 58 configured to form such a hologram 60 in a blister pack 24 or other packaging (FIG. 8A). Once embossed into the product 12 (as shown in the closure cap type of packaging 72 shown in FIG. 8B), the simple or complex holographic feature is configured to diffract light differently at different viewing angles, thereby changing colors. This will provide an additional overt tracking feature that is difficult to knock-off by counterfeiters for the same reasons set forth above.

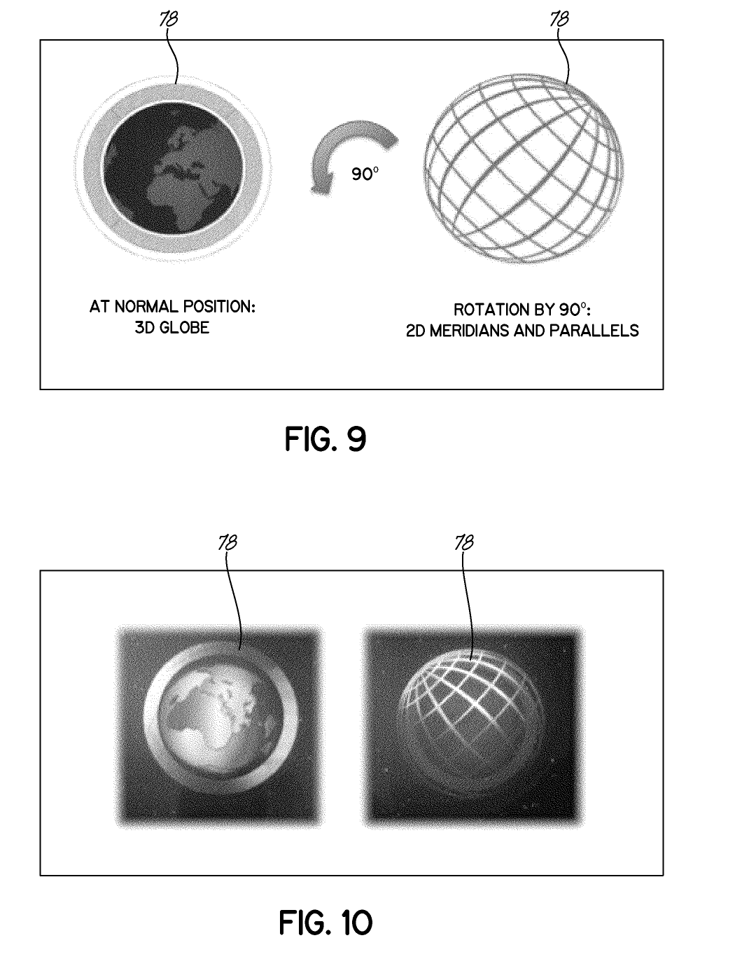

An example of the Level 2 hologram verification may include a hologram security feature (described as element 78 below) that is embossed or otherwise applied to a blister pack 24 or similar packaging such that at a first angle of viewing, the hologram 78 presents a first image such as a globe, and at a second angle of viewing, the hologram 78 presents a second and distinct image such as 2D meridians and parallels forming a globe shape. A schematic illustration of this concept is provided at FIG. 9, while an actual hologram 78 in use from the two different viewing angles is shown in FIG. 10. It will be readily understood that the particular embossing tool inserts 56 used to form such detailed hologram images will be extremely difficult, if not impossible to copy by an intended counterfeiter. Especially when used in conjunction with the hidden security features 20 described above, such a hologram 78 makes counterfeiting effectively impossible.

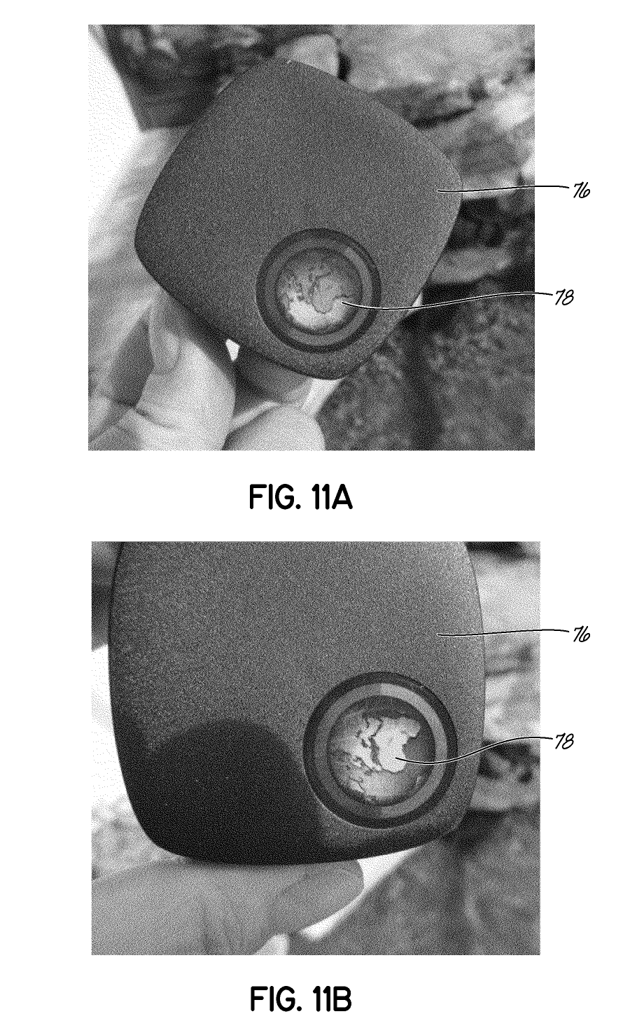

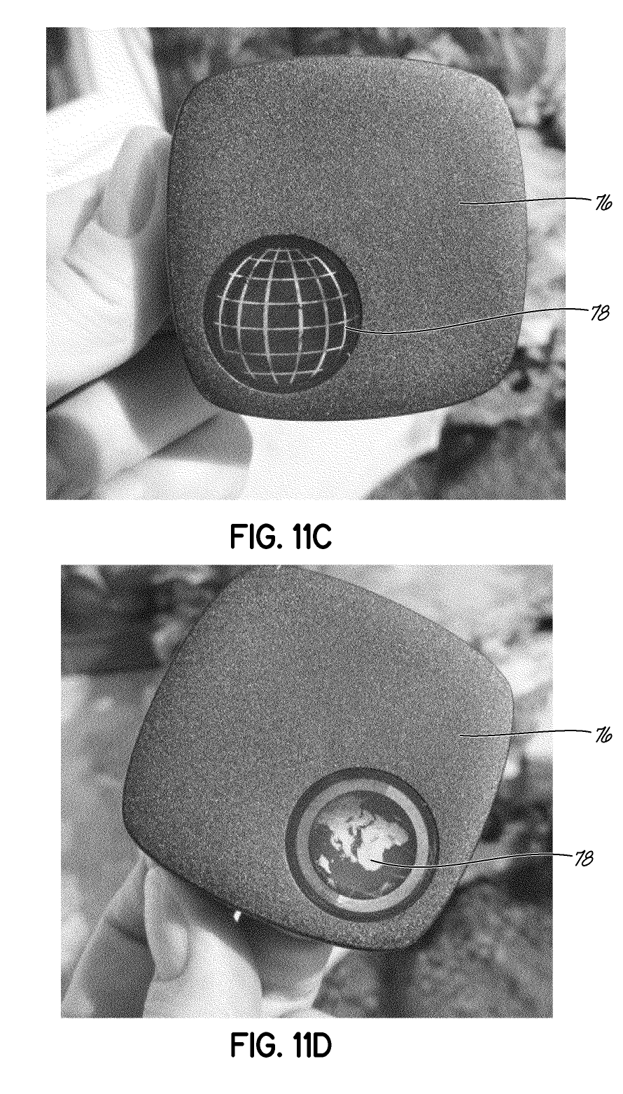

FIGS. 11A through 11D show an actual cap closure type of packaging 76 that could be used with pharmaceuticals (e.g., such as in a pill bottle 68 setting) including the Level 2 hologram security feature 78 shown at different viewing angles or angles of rotation of the cap closure packaging 76. To this end, the colors of the globe image of the hologram security feature 78 change when rotating from the view shown in FIG. 11A to that shown in FIG. 11B. Further rotations lead to a change in appearance of the hologram security feature 78 to the 2D meridians and parallels shown in FIG. 11C, and then back to the globe image at FIG. 11D. It will be understood that while the color layout of the globe image in FIG. 11D may be further different from those shown in FIGS. 11A and 11B, the hologram security feature 78 appearances could be designed to repeat within a rotation of 90° to 120° in some embodiments.

As an example of the Level 3 verification, detectable irregularities such as microtext 36 or reflected diffractive patterns formed by gratings or other similar structures may be included in the hologram images as well. More particularly, on the surface, the hologram 78 consists of many superimposed periodic structures, such as gratings with lateral sizes of less than 6 microns, typically less than 2 microns. The depth of these structures is between 50 nanometers and 1 micron. The hologram 78 can cover a total area of 30 microns by 30 microns in size up to very large sizes (tens of square centimeters, if necessary). If a part of the hologram 78 does not contain any periodic structures, but is flat for example, the diffraction efficiency of the hologram 78 is decreased but the information within the hologram 78 is maintained and the hologram 78 can still be projected. Areas within the hologram 78 surface which are flat, for example can form a microtext 36. One preferable embodiment is to create a hologram 78 which upon projection by a laser displays a barcode (one or two dimensional), the barcode has open or cryptographically secured information about the product 12, for example, it might contain the name of the product 12, a tool number, a batch number, etc. Microtext 36 within the area of the hologram 78 may consist of small areas (e.g., 2 to 100 microns in size) that simply do not contain a holographic grating. In a preferred embodiment, the microtext 36 will be an alphanumeric sequence that acts as a digital signature for verification of the content of the barcode. A measurement device, such as a mobile phone, or a camera linked with a computer, will be able to read these features. These hidden elements associated with the hologram 78 are typically not overt and therefore will be difficult to copy for counterfeiters, much like the hidden security features 20 described in detail above.

In another preferred embodiment, the surface area of the hologram 78 is not flat, but modulated in height, for example it might contain two or more regions of different height (the height differences might vary between 0.1 micron and 100 microns). These areas can form for example a linear or 2 dimensional barcode where each area of the barcode contains grating lines that are included in the hologram 78. A preferred lateral size of this barcode will be between 5 microns and 500 microns. These height differences can be read with an accurate 3D scanner, such as an interferometer, a pOCT reader (optical coherence tomography), a confocal microscope, etc., to reveal the encoded information. In another example, the embossing tooling used to make the hologram 78 may include detectable small defects unique to the tooling, which may be read by 3D scanning equipment such as that described above to confirm that the authentic tooling placed the security feature hologram 78 on the product packaging 24. Regardless of what type of irregularity or defect is included with the hologram 78 as part of the Level 3 verification, the combination of security features enables further verification and authentication processes at various locations in the supply chain 10 for pharmaceutical products 12.

The multiple level hologram verification can be used as an alternative to, or in addition to, the hidden security features 20 revealed with a laser pointer 22.

While the present invention has been illustrated by a description of exemplary embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in any combination depending on the needs and preferences of the user. This has been a description of the preferred methods of practicing embodiments of the invention as currently known. However, the invention itself should only be defined by the appended claims.

What is claimed is:

1. A method for discouraging counterfeiting of pharmaceutical products, the method comprising:
providing a packaging with a genuine pharmaceutical and with a hidden security feature formed integrally by material defining the packaging;
verifying authenticity of the pharmaceutical by directing a laser beam through the packaging at the hidden security feature to reveal the hidden security feature on a surface behind the packaging.

2. The method of claim 1, wherein providing the packaging further includes adding one or more additional security features to the packaging, and wherein verifying authenticity of the pharmaceutical further includes confirming visually or with a machine that the additional security features are present on the packaging.

3. The method of claim 2, wherein adding one or more additional security features to the packaging further includes forming microtext integrally into the material defining the packaging, the microtext defining depth and lateral dimensions between 2 microns and 100 microns.

4. The method of claim 2, wherein adding one or more additional security features to the packaging further includes forming a hologram integrally into the material defining the packaging, the hologram acting as an overt security feature on the packaging.

5. The method of claim 4, wherein the hologram diffracts light differently at different viewing angles so as to visually change color at the different viewing angles.

6. The method of claim 5, wherein the hologram diffracts light so as to present a first image at some viewing angles and so as to present a distinct second image at other viewing angles.

7. The method of claim 6, wherein the hologram includes at least one of the following formed integrally within the hologram:
the hidden security feature that is revealed by the laser beam; and
a detectable irregularity of the hologram that is covert but identifiable with a 3D scanner.

8. The method of claim 1, further comprising:
loading the packaging with the hidden security feature into an outer packaging box; and
forming a barcode on the outer packaging box for identification or serialization of the packaging loaded into the outer packaging box, the barcode and the hidden security feature collectively defining a digital signature for uniquely identifying and verifying the authenticity of the pharmaceutical contained within the packaging.

9. The method of claim 1, wherein the packaging includes a blister pack with a foil coating, and the method further comprises:
removing a portion of the foil coating adjacent to the hidden security feature so that the laser beam may be directed through the packaging to reveal the hidden security feature.

10. The method of claim 1, wherein the packaging includes a pill bottle with a closure cap, wherein the hidden security feature is located in at least one of the pill bottle and the closure cap such that verifying the authenticity of the pharmaceutical further includes directing the laser beam through the at least one of the pill bottle and the closure cap.

11. The method of claim 1, wherein verifying the authenticity of the pharmaceutical by directing a laser beam through the hidden security feature authenticates the pharmaceutical within 1 second without reliance on communication with external databases during the verifying of the authenticity of the pharmaceutical.

12. A pharmaceutical product configured to discourage counterfeiting, the pharmaceutical product comprising:
one or more dosage forms of a genuine pharmaceutical; and
a packaging configured to receive and securely hold the one or more dosage forms, the packaging defined by a material and including a hidden security feature that is formed integrally by the material defining the packaging,
wherein the hidden security feature deflects laser energy transmitted through the packaging such that a laser beam directed through the packaging at the hidden security feature reveals the hidden security feature on a surface behind the packaging to verify the authenticity of the pharmaceutical.

13. The pharmaceutical product of claim 12, wherein the packaging further comprises:
one or more additional security features, which are configured to be confirmed visually or with a machine as present on the packaging when verifying the authenticity of the pharmaceutical.

14. The pharmaceutical product of claim 13, wherein the additional security features are located at a different position on the packaging than the hidden security feature.

15. The pharmaceutical product of claim 13, wherein the additional security features further comprise:
microtext formed integrally into the material defining the packaging, the microtext defining depth and lateral dimensions between 2 microns and 100 microns.

16. The pharmaceutical product of claim 13, wherein the additional security features further comprise:
a hologram formed integrally into the material defining the packaging, the hologram acting as an overt security feature on the packaging.

17. The pharmaceutical product of claim 16, wherein the hologram diffracts light differently at different viewing angles so as to visually change color at the different viewing angles.

18. The pharmaceutical product of claim 17, wherein the hologram diffracts light so as to present a first image at some viewing angles and so as to present a distinct second image at other viewing angles.

19. The pharmaceutical product of claim 18, wherein the hologram includes at least one of the following formed integrally within the hologram:
the hidden security feature that is revealed by the laser beam; and
a detectable irregularity of the hologram that is covert but identifiable with a 3D scanner.

20. The pharmaceutical product of claim 12, further comprising:
an outer packaging box configured to receive the packaging; and
a barcode formed on the outer packaging box for identification or serialization of the packaging loaded into the outer packaging box, the barcode and the hidden security feature collectively defining a digital signature for uniquely identifying and verifying the authenticity of the pharmaceutical contained within the packaging.

21. The pharmaceutical product of claim 12, wherein the packaging includes a blister pack with a foil coating, and at least a portion of the foil coating must be removed at the hidden security feature to enable the laser beam to be directed through the hidden security feature.

22. The pharmaceutical product of claim 12, wherein the packaging includes a pill bottle with a closure cap, wherein the hidden security feature is located in at least one of the pill bottle and the closure cap.
